(19) United States
(12) Patent Application Publication
(10) Pub. No.: US 2006/0081294 A1
(43) Pub. Date: Apr. 20, 2006

(54) Pressure regulator with integrated flow switch

(75) Inventors: Robert Drexel, Smithtown, NY (US); Sean Patrick O'Grady, Chesterfield, MO (US)

Correspondence Address: HOFFMANN & BARON, LLP, 6900 JERICHO TURNPIKE, SYOSSET, NY, 11791, US

(73) Assignee: FESTO Corporation

(21) Appl. No.: 10/966,182

(22) Filed: Oct. 15, 2004

(51) Int. Cl. F16K 37/00

(52) U.S. Cl. 137/554

(57) ABSTRACT

A pressure regulating valve with an integrated flow switch to sense when full flow has been achieved through the regulator includes a valve housing, a control member, a movable setting member, a first electrical contact disposed on the movable setting member and a second electrical contact disposed on an inner wall of the housing. The housing also has a primary duct, a secondary duct, a transfer opening fluidly connecting the primary duct and the secondary duct and an interior chamber. The control member is movable between an open and a closed position for alternately opening and closing the transfer opening. The movable setting member is disposed in the housing interior chamber and is engageable with the movable control member to move the control member between the open and closed positions. When the control member is in one of its open and closed positions, the first and second electrical contacts make contact, thereby closing a circuit to indicate that full flow has been achieved. In an alternative embodiment, a sensing mechanism is provided for sensing the relative location of the setting member.

### FIELD OF THE INVENTION

The present invention relates generally to pressure regulating devices and, more particularly, to a pressure regulating valve having a movable control diaphragm and an electrical contact closure disposed on the diaphragm to sense when full flow through the regulator is achieved.

### BACKGROUND OF THE INVENTION

The most common types of pressure regulating valves have a primary duct subject to a primary pressure, a secondary duct for tapping of a regulated secondary pressure and a movable control member for controlling the flow of fluid between the primary and the secondary duct. The movable control member typically includes a flexible diaphragm, an adjustable spring and a valve seat. The adjustable spring creates a downward force on the top side of the diaphragm to open the main valve seat and thereby permit fluid flow through the valve. The diaphragm generally has a proportional movement up and down in direct relationship with the main air flow seat and sealing disk. The bottom side of the diaphragm is subjected to the output pressure (P2) which creates an opposing force to counteract the down force of the adjustable spring and cause a force balance which in turn closes the main seat (when balance is achieved).

A pressure regulating valve of this type is disclosed in U.S. Pat. No. 6,554,017 to Berger, the specification of which is incorporated herein by reference. Such valves are typically utilized more particularly in connection with compressed air handling systems and in compressed air supply networks and are generally employed to maintain a constant working pressure, available on the secondary side, in a manner substantially independent of variations in pressure on the secondary side.

In such systems, it is often desirable to monitor the flow through the regulator to ensure that full flow is achieved. This is typically accomplished by providing an array of pressure sensors to measure fluid pressure both upstream and downstream of the regulator. One obvious drawback of implementing such pressure sensors and their associated electronic circuitry is the added complexity and cost of the system.

Accordingly, it would be desirable eliminate the need for pressure sensors to monitor flow through the pressure regulator. In this regard, it would be desirable to utilize the movement of the pressure regulator diaphragm itself to determine when full flow is achieved through the regulator.

### SUMMARY OF THE INVENTION

The present invention is a pressure regulating valve with an integrated flow switch to sense when full flow has been achieved through the regulator. In particular, the pressure regulating valve of the present invention generally includes a valve housing, a control member, a movable setting member, a first electrical contact disposed on the movable setting member and a second electrical contact disposed on an inner wall of the housing. The housing also has a primary duct, a secondary duct, a transfer opening fluidly connecting the primary duct and the secondary duct and an interior chamber. The control member is movable between an open and a closed position for alternately opening and closing the transfer opening. The movable setting member is disposed in the housing interior chamber and is engageable with the movable control member to move the control member between the open and closed positions. When the control member is in one of its open and closed positions, the first and second electrical contacts make contact, thereby closing a circuit to indicate that full flow has been achieved.

In a preferred embodiment, the setting member includes a rigid body and a flexible diaphragm and the first electrical contact is disposed on either or both the rigid body and the diaphragm. Also, the interior chamber of the housing is preferably in fluid communication with the secondary duct via a connecting duct and movement of the setting member is influenced by a change in pressure in the interior chamber.

The pressure regulating valve of the present invention may also include an adjustable spring, wherein movement of the setting member is biased by the adjustable spring. Additionally, the valve may include a visual display or an audible indicator electrically connected with the first and second electrical contacts for signaling when the first and second electrical contacts make contact.

In an alternative embodiment, the pressure regulating valve includes a valve housing, a control member, a setting member and a sensing mechanism for sensing a relative location of the setting member. The sensing mechanism may be one of a Reed or Hall proximity switch or a linear displacement sensor for variable feedback of the setting member location. The valve may also include a microprocessor for receiving information obtained from the sensing mechanism and calculating a desired parameter based on the received information. The valve may also include a display for displaying a parameter based on the relative location of the setting member sensed by the sensing mechanism. The sensing mechanism may be designed to sense the location of either the rigid body or the flexible diaphragm of the setting member.

The preferred embodiments of the pressure regulator with integrated flow switch as well as other objects, features and advantages of this invention, will be apparent from the following detailed description, which is to be read in conjunction with the accompanying drawings.

### BRIEF DESCRIPTION OF THE DRAWINGS

FIG. 1 is a cross-sectional view of the pressure regulator with integrated flow switch formed in accordance with the present invention.

FIG. 2 is a cross-sectional view of an alternative embodiment of the pressure regulator with integrated flow switch formed in accordance with the present invention.

### DETAILED DESCRIPTION OF THE PREFERRED EMBODIMENTS

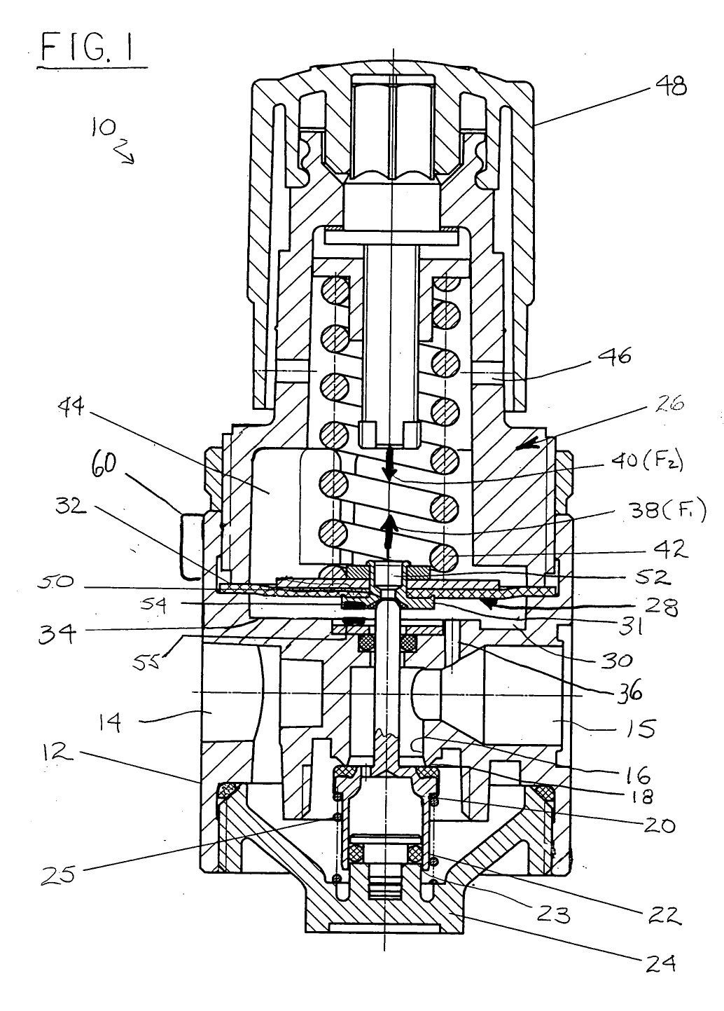

FIG. 1 shows a longitudinal cross-section of a pressure regulating valve 10, which could also be termed a pressure regulator, formed in accordance with the present invention. The valve 10 generally includes a valve housing 12 having a primary duct 14 and a secondary duct 15, preferably arranged on opposite sides thereof. Typically, such a valve 10 is in the form of a so-called servicing device, which is employed for the production or conditioning of compressed air in supply systems connected to the primary duct 14 and serving for the connection at the secondary duct 15 of pressure medium lines leading to further equipment or further types of servicing devices.

Specifically, during operation of the pressure regulating valve 10, compressed air at a primary pressure may be supplied by way of the primary duct 14. Compressed air at a secondary pressure may then be tapped at the secondary duct 15 and may be passed on to one or more loads. The secondary pressure, as a rule, is less than the primary pressure and is able to be set using the pressure regulating valve 10 as needed.

The primary duct 14 and the secondary duct 15 are fluidly connected with one another by way of a transfer opening 16, which is surrounded by a primary valve seat 18. The fluid connection produced by the transfer opening 16 between the primary and secondary ducts 14 and 15 is controlled by a shifting control member 20, which is able to be moved in relation to the primary valve seat 18 into a closed position or into different open positions. The control member 20 is in sealing engagement with the primary valve seat 18 in the closed position and so separates the primary duct 14 from the secondary duct 15. In the open positions, there is a smaller or larger distance between the control member 20 and the primary valve seat 18, which provides a fluid path for the compressed air or some other fluid pressure medium through the valve housing 12.

The control member 20 is designed like a plunger and possesses an elongated plunger body whose rear terminal part 22 is slidingly engaged with a bottom portion 24 of the valve housing 12. The rear terminal part 22 of the control member 20 is preferably provided with a sealing lip 23, which surrounds a cylindrical housing projection of the bottom portion 24 of the valve housing in a sliding manner with sealing contact. The sealing lip 23 preferably has a check valve function so that, given a suitable pressure differential, it permits fluid flow from the secondary duct 15 to the primary duct 14 and prevents flow in the opposite direction. The rear terminal part 22 of the control member 20 is further provided with a spring 25 for biasing the control member against the primary valve seat 18 in a closed position.

The pressure regulating valve 10 renders possible a substantially constant regulation of the secondary pressure to be at a desired gage pressure value below the primary pressure. The desired secondary pressure may be set at various different values by a presetting means 26. The presetting means 26 includes a setting member 28 arranged in a moving manner in a fluid chamber 30, termed the comparison chamber, formed within the valve housing 12. The setting member 28 preferably includes a rigid body 31 movably connected to the valve housing 12 by way of a diaphragm 32 manufactured of a material with rubber-elastic properties. The movable setting member 28, with rigid body 31 and diaphragm 32, define one wall of the comparison chamber 30 and the valve housing 12 defines an opposite wall 34 of the chamber. Accordingly, the volume of the comparison chamber 30 is therefore dependent on the instantaneous position of the setting member 28.

The comparison chamber 30 is in constant fluid communication with the secondary duct 15 by way of at least one connecting duct 36. It is in this manner that the comparison chamber 30 is always filled with fluid and the fluid pressure within the comparison chamber is normally equal to the secondary pressure. The connecting duct 36 can accordingly also be termed an interrogation duct, which interrogates the fluid pressure within the outlet duct 15 and transmits this pressure to the comparison chamber 30.

Due to the fluid pressure in the comparison chamber 30, the setting member 28 is constantly urged in an upward direction as indicated in FIG. 1 by the arrow 38. The resulting upward force F₁ is opposed by a downward force F₂, termed the presetting force and indicated by the arrow 40, which is produced by a spring 42 whose biasing action is able to be set.

The spring 42, which is preferably a helical compression spring, extends in the working example in an elongated spring chamber 44 delimited by the valve housing 12. Via one or more outlet ducts 46 extending through the housing 12, the spring chamber 44 is constantly connected with the outside or atmosphere so that it is at atmospheric pressure.

For setting the presetting force F₂ the presetting means 26 includes a setting means preferably in the form of a rotary head 48 mounted in a rotatable manner on the valve housing 12. In a conventional manner, rotation of the rotary head 48 translates to a longitudinal force on the spring 42 to change the bias of the spring and, accordingly, the presetting force F₂ on the setting member 28 may now be varied. The presetting force F₂ could additionally or alternatively to the mechanical preset means present in the working example also be caused by fluid force or by electromagnetic proportional magnets.

The setting member 28 cooperates with the control member 20 to define a secondary valve seat 50. In particular, if the rigid body 31 of the setting member 28 is in contact with the control member 20, a venting opening 52, formed through the rigid body, will be closed. If on the other hand the setting member 28 assumes a position spaced from the control member 20, the venting opening 52 will be open. When the venting opening 52 in the rigid body 31 is open, there is a fluid connection between the outlet duct 15 and the atmosphere so that pressure medium held in the outlet duct may make its way through the venting opening 52, the spring chamber 44 and the outlet ducts 46 into the atmosphere. This at the same time leads to a reduction in the secondary pressure.

In operation, when a secondary pressure in the secondary duct 15 is less than a desired secondary pressure, the control member 20 is shifted by the setting member 28 into an open position. This is because the presetting force F₂ at this time is still larger than the opening force F₁ provided by the instantaneous secondary pressure in the secondary duct 15. Thus, the setting member 28 is biased by way of the spring 42 toward the control member 20, which in turn is shifted off of the primary valve seat 18 and out of a closed position into an open position. In its open position, the control member 20 permits fluid flow from the primary duct 14 to the secondary duct 15 through the transfer opening 16.

As compressed air flows from the primary duct 14 to the secondary duct 15, the secondary pressure, as well as the opening force F₁, is increased due to an increase in pressure in the comparison chamber 30. Accordingly, the increase in pressure in the comparison chamber 30 will act on the diaphragm 42 of the setting member 28 to gradually shift the setting member upward in the opening direction. The control member 20, biased by the spring 25, follows the shifting of the setting member 28 and gradually returns to its closed position whereby the primary valve seat 18 is sealed and fluid flow through the transfer opening 16 is stopped.

If, however, the secondary pressure should continue to climb above the desired value, the setting member 28 will move further in the opening direction so as to be lifted clear of the control member 20 because the control member is prevented from moving farther due to its reaching its closed position. As a result, the venting opening 52 in the rigid body 31 of the setting member 28 is opened so that pressure medium may make its way directly from the secondary duct 15 by way of the venting opening and the venting duct 46 into the atmosphere. With the opening force F₁ thus being reduced, the rigid body 31 of the setting member 28 will again shift downward in the closing direction until it engages the control member 20, wherein the venting opening 52 is sealed off. When ultimately the secondary pressure has reached the desired value, a condition of force equilibrium will become established between the opening force F₁ and the presetting force F₂.

In order to accurately monitor the exact opening and closing of the transfer opening 16, the valve 10 of the present invention is provided with a set of electrical contacts 54 and 55, which alternatively open or close an electrical circuit to indicate when full fluid flow through the valve is achieved. In particular, in a preferred embodiment, the setting member 28 is provided with a first electrical contact 54 facing the comparison chamber 30 and the chamber wall 34 opposite the setting member is provided with a second electrical contact 55. The first electrical contact 54 may be disposed on either or both the rigid body 31 or the diaphragm 32 of the setting member 28. In either case, the first and second electrical contacts 54 and 55 make contact when the setting member 28 is in its downward fully closed position within the comparison chamber 30. Thus, with the added contact arrangement of the present invention, whenever the setting member 28 is fully closed and, thereby, the control member 20 is extended fully open to permit maximum fluid flow, a contact closure is made allowing for electrical feedback into a control scheme.

In an alternative embodiment, the first electrical contact 54 can be disposed on the opposite surface of the setting member 28 outside the comparison chamber 30 and the second electrical contact 55 can be disposed on a different surface of the housing facing the first electrical contact. In this manner, the first and second electrical contacts 54 and 55 will only make contact when the setting member 28 is in its upward fully open position and the control member 20 is in its fully closed position.

In either embodiment, the first and second electrical contacts 54 and 55 are connected to electrical leads (not shown) which in turn can be connected, for example, to a circuit including a visual display 60 or an audible indicator that signals when the transfer opening 16 is open or closed.

The first and second electrical contacts 54 and 55 may take any form so long as they do not interfere with the travel of the setting member 28. For example, the electrical contacts 54 and 55 may be made from an electrically conductive foil and may be bonded to their respective surfaces. Alternatively, the contacts 54 and 55 may consist of an electrically conductive ink and may be deposited on their respective surfaces by a lithographic technique.

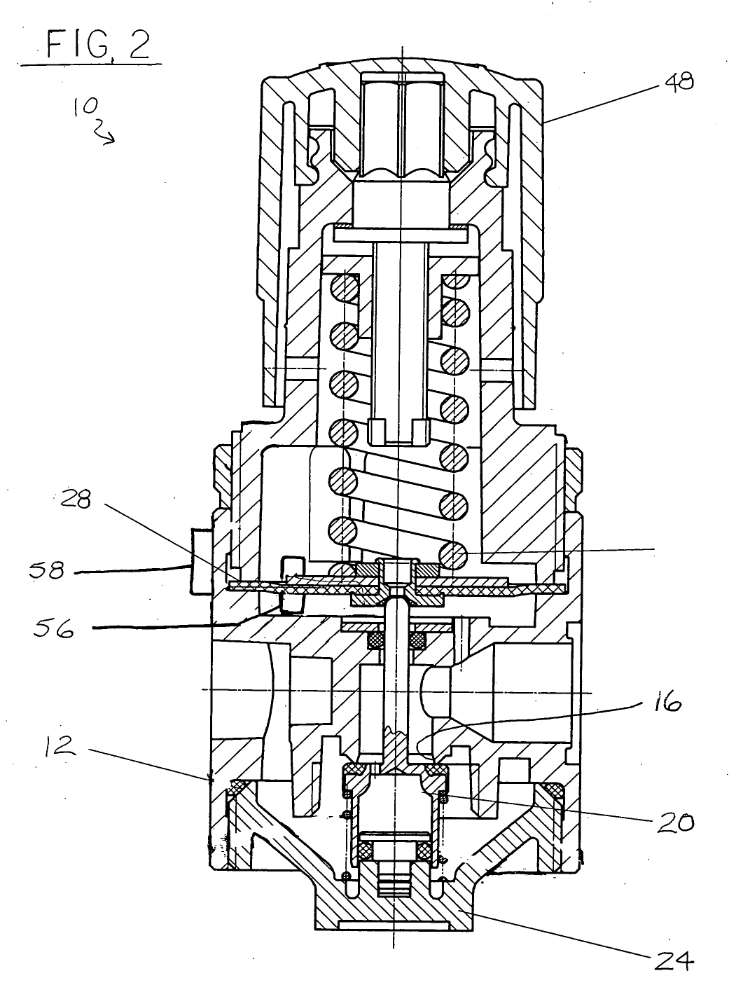

In another alternative embodiment shown in FIG. 2, the first and second electrical contacts 54 and 55 can be replaced by a sensing mechanism 56 that determines the relative location or proportional travel of the setting member 28 within the comparison chamber. The sensing mechanism 56 may, for example, take the form of a Reed or Hall proximity switch, or even a linear displacement sensor for variable feedback (analog) of setting member movement. The information obtained by the sensing mechanism 56 can in turn be sent to a microprocessor 58 which can calculate and display the relative transfer opening 16 of the regulator 10 and the approximate volume of flow based on the received information.

Although the preferred embodiments of the present invention have been described with reference to the accompanying drawing, it is to be understood that the invention is not limited to those precise embodiments, and that other changes and modifications may be made by one skilled in the art without departing from the scope or spirit of the invention.

What is claimed is:

1. A pressure regulating valve comprising:
a valve housing having a primary duct, a secondary duct, a transfer opening fluidly connecting said primary duct and said secondary duct, an interior chamber and at least one inner wall;
a control member movable between an open and a closed position for alternately opening and closing said transfer opening;
a movable setting member disposed in said housing interior chamber, said movable setting member being engageable with said movable control member to move said control member between said open and closed positions;
a first electrical contact disposed on said movable setting member; and
a second electrical contact disposed on said housing inner wall, wherein said first and second electrical contacts make contact when said control member is in one of said open and closed positions.

2. A pressure regulating valve as defined in claim 1, wherein said setting member comprises a rigid body and a flexible diaphragm, said first electrical contact being disposed on said rigid body.

3. A pressure regulating valve as defined in claim 1, wherein said setting member comprises a rigid body and a flexible diaphragm, said first electrical contact being disposed on said diaphragm.

4. A pressure regulating valve as defined in claim 1, wherein said interior chamber is in fluid communication with said secondary duct via a connecting duct and wherein movement of said setting member is influenced by a change in pressure in said interior chamber.

5. A pressure regulating valve as defined in claim 1, further comprising an adjustable spring, wherein movement of said setting member is biased by said adjustable spring.

6. A pressure regulating valve as defined in claim 1, further comprising at least one of a visual display or an audible indicator electrically connected with said first and second electrical contacts for signaling when said first and second electrical contacts make contact.

7. A pressure regulating valve comprising:
a valve housing having a primary duct, a secondary duct, a transfer opening fluidly connecting said primary duct and said secondary duct, an interior chamber and at least one inner wall;
a control member movable between an open and a closed position for alternately opening and closing said transfer opening;
a movable setting member disposed in said housing interior chamber, said movable setting member being engageable with said movable control member to move said control member between said open and closed position; and
a sensing mechanism for sensing a relative location of said setting member within said interior chamber.

8. A pressure regulating valve as defined in claim 7, wherein said sensing mechanism is one of a Reed or Hall proximity switch.

9. A pressure regulating valve as defined in claim 7, wherein said sensing mechanism is a linear displacement sensor for variable feedback of said setting member location.

10. A pressure regulating valve as defined in claim 7, further comprising a microprocessor for receiving information obtained from said sensing mechanism and calculating a desired parameter based on said received information.

11. A pressure regulating valve as defined in claim 7, further comprising a display for displaying a parameter based on the relative location of said setting member sensed by said sensing mechanism.

12. A pressure regulating valve as defined in claim 7, wherein said setting member comprises a rigid body and a flexible diaphragm, said sensing mechanism sensing a relative location of said rigid body.

13. A pressure regulating valve as defined in claim 7, wherein said setting member comprises a rigid body and a flexible diaphragm, said sensing mechanism sensing a relative location of said diaphragm.

14. A pressure regulating valve as defined in claim 7, wherein said interior chamber is in fluid communication with said secondary duct via a connecting duct and wherein movement of said setting member is influenced by a change in pressure in said interior chamber.

15. A pressure regulating valve as defined in claim 1, further comprising an adjustable spring, wherein movement of said setting member is biased by said adjustable spring.
